(19) United States
(12) Patent Application Publication
(10) Pub. No.: US 2006/0289604 A1
(43) Pub. Date: Dec. 28, 2006

(54) FRICTION STIR WELDING APPPARATUS

(75) Inventors: Rudolph Zettler, Geesthacht (DE); Shahram Sheikhi, Escheburg (DE); Mathias Beyer, Reppenstedt (DE); Jorge F. dos Santos, Avendorf (DE); Arne Roos, Juliusburg (DE); Henry Loitz, Hamburg (DE)

Correspondence Address: HOVEY WILLIAMS LLP, 2405 GRAND BLVD., SUITE 400, KANSAS CITY, MO, 64108, US

(73) Assignee: GKSS-FORSCHUNGSZENTRUM GEESTHACHT GMBH, Geesthacht (DE)

(21) Appl. No.: 11/426,876

(22) Filed: Jun. 27, 2006

(30) Foreign Application Priority Data
Jun. 27, 2005 (DE) 102005029882.6

(51) Int. Cl. B23K 20/12

(52) U.S. Cl. 228/2.1

(57) ABSTRACT

The invention illustrates and describes an apparatus for friction stir welding, having a pin (3) and a first friction surface segment (4), the pin (3) and the first friction surface segment (4) being rotationally driven about an axis of rotation (6), and the first friction surface segment (4) having a first friction surface (5) for resting on a workpiece (2). The object of providing a friction stir welding apparatus which can be used to better set the energy which is introduced into the workpiece by way of the friction between pin and friction surface, on the one hand, and workpiece, on the other hand, is achieved by virtue of the fact that a first inner segment (7) is provided, having a first inner friction surface (8) for resting on a workpiece (2, 2′), that the first inner segment (7) surrounds the pin (3), that the first friction surface segment (4) surrounds the first inner segment (7), and that the first friction surface segment (4) is rotationally driven independently of the first inner segment (7).

### RELATED APPLICATION

This Application claims priority of German Application Serial No. DE 10 2005 029 882.6, filed Jun. 27, 2005, which is hereby incorporated by reference herein.

### BACKGROUND OF THE INVENTION

1. Field of the Invention

The present invention relates to an apparatus for friction stir welding, having a pin and a first friction surface segment, the pin and the first friction surface segment being rotationally driven about an axis of rotation, and the first friction surface segment having a first friction surface for resting on a workpiece.

2. Discussion of Prior Art

The principle of friction welding has been known from the prior art for many years and involves a relative movement between two workpieces while these workpieces are being pressed against one another along a contact line. The friction generates a plasticized zone along the contact line, so that when the relative movement comes to a stop the plasticized region can solidify and the workpieces are joined to one another. This technique is advantageous in particular for welding aluminium and its alloys. With conventional welding techniques, these materials can combine with the atmospheric oxygen to form oxides preventing the formation of a weld seam of sufficient strength. By contrast, this disruptive effect of oxide formation does not occur during friction welding.

However, one drawback of friction welding is that a relative movement is required between the workpieces that are to be joined. This constitutes a problem in particular if large workpieces are to be joined to one another, since this requires apparatuses and fixtures which have to hold the entire workpieces and move them with respect to one another. To avoid this problem, there has been a move towards friction stir welding (FSW). It is known from WO 93/10935 to introduce a pin into the joint between workpieces which adjoin one another and are to be joined to one another and to then set this pin in rotation, the pin having a higher hardness and a higher melting point than the material of the workpieces. While the pin is rotating, the workpieces are pressed onto one another, so that the friction between the pin and the workpieces plasticizes the edge region of both workpieces. If the pin is moved onwards along the joint, the plasticized material solidifies again and it is in this way possible to produce a weld seam.

To achieve sufficient friction even in the region close to the surface of the joint, it has proven advantageous to provide shoulders above and/or below the pin, resting on a surface of the workpieces that are to be joined and, together with the pin, also rubbing against the material. To this end, it is known from U.S. Pat. No. 6,199,745 to control the force with which the shoulders are pressed onto the top side and the underside of the workpieces separately in order to achieve an optimum distribution of heat over the cross-sectional area of the joint.

U.S. Pat. No. 6,758,382, on which the present invention is based, discloses controlling the pressures with which the upper and lower shoulders are pressed onto the surfaces of the workpiece and the position of the shoulders relative to the workpieces. Furthermore, the lower shoulder is releasably connected to the pin, so that it can easily be removed and therefore the apparatus can be used even in situations in which the workpieces are resting on a base.

However, the friction of the pin and the shoulder(s) exerts forces on the workpieces, and these forces have to be absorbed by a workpiece fixture. If an apparatus for friction stir welding is to be used with a conventional robot, the problem often arises that on account of its design the robots do not have the required stability to absorb the forces generated by the pin and the shoulders and running in the plane of the weld seam.

A further problem is that the properties of the weld seam are determined by the temperature distribution and the mass transfer caused by the friction between pin and shoulder(s) and the workpieces. Therefore, the properties of the weld seam can only be influenced by changing the rotational speed of the pin and shoulder(s) and the speed at which the pin is moved linearly along the joint, and consequently targeted influencing of the properties is only possible with difficulty.

Finally, the friction stir welding apparatuses which are known from the prior art are designed for a specific arrangement of the workpieces which are to be joined to one another and cannot be used for other geometries. Therefore, when changing the type of workpiece, it is also necessary to change the friction stir welding apparatus, which involves changeover times and associated costs. Therefore, it is desirable to provide a universally employable apparatus for friction stir welding.

### SUMMARY OF THE INVENTION

Therefore, the present invention is based on the object of providing a friction stir welding apparatus which can be used to better set the energy which is introduced into the workpiece by way of the friction between pin and friction surface, on the one hand, and workpiece, on the other hand.

This object is achieved by virtue of the fact that a first inner segment is provided, having a first inner friction surface for resting on a workpiece, that the first inner segment surrounds the pin, that the first friction surface segment surrounds the first inner segment, and that the first friction surface segment is rotationally driven independently of the first inner segment.

During welding, the first friction surface is generally arranged between the apparatus holder with the drive and the workpiece and can therefore be considered the “upper” friction surface. However, it is also conceivable for the workpiece to be arranged between the holder and the first friction surface, in which case the first friction surface bears against the workpiece “from below”.

The first friction surface segment having the first friction surface and the pin can be set in rotation independently of one another, with the result that the energy which is introduced into the material of the workpieces to be joined by the friction can be set differently at the surface and at the joints by using different rotational speeds. In particular, it is in this way possible to achieve a uniform temperature distribution in the region of the subsequent weld seam, which is associated with greater homogeneity of the weld seam microstructure. With the apparatus according to the invention, it is in particular possible for the energy introduced via the surface of the workpieces to be set independently of the energy introduced via the contact surfaces. Moreover, the mass transfer in the region of the weld seam can be controlled by the separate setting of the rotational speeds of first friction surface and pin.

If the pin and the first friction surface are set in rotation in opposite directions to one another, the result, independently of the possibility of influencing the properties of the weld seam, is the possibility of reducing or eliminating the forces, which act on the workpieces and result from the friction, in the plane of the direction in which the weld seam extends, because the forces caused by the pin and the first friction surface are then acting in opposite directions. The resulting moment can be substantially neutralized as a result. An apparatus of this type can also be used together with carrier systems which do not themselves have a particularly high rigidity, in order to absorb the relatively high moments which otherwise occur. This allows the use of conventional robots.

The first inner segment, which surrounds the pin and has a larger external diameter than the pin, has the effect that the forces which are exerted on the workpieces by the pin and the first inner segment, on the one hand, and the first friction surface, on the other hand, can substantially cancel each other out, provided that the first friction surface segment having the first friction surface is rotating in the opposite direction to the pin and to the first inner segment. The first inner segment, rotating with the pin, having a larger diameter and an inner friction surface bearing against the workpieces, in particular compensates for the effect which emanates from the much larger diameter of the first friction surface segment and the associated higher torque.

The pin may preferably be joined to the first inner segment, so that the first inner segment accommodates the pin, in which case, in a particularly preferred embodiment, the pin and the first inner segment are formed integrally, which further simplifies their structure.

In a further preferred embodiment, in addition to being rotatable, the pin can also be displaced linearly in the direction in which it extends, in which case a periodic displacement may also take place, so that the pin can also rub along the contact surfaces with a movement perpendicular to the direction in which the weld seam extends. As a result, it is possible to influence not just the mass transfer in the plane of the first friction surface but also the mass transfer in the direction in which the pin extends.

In a preferred embodiment, the first friction surface segment may be surrounded by a first outer segment. It is also preferable for the first outer segment to be able to rotate freely relative to the first friction surface segment. This makes it possible to prevent material from being thrown up away from the weld seam and the formation of burrs as a result of the rotation of the first friction surface. This throwing-up of material would involve the thickness of the weld seam being less than that of the adjoining material, with the result that the weld seam may fail prematurely, representing a likely breaking point. The first outer segment can be used to prevent a “geometric” weakening of the weld seam of this nature, since this segment stops material from being thrown up.

A structure of this type having an outer segment is also advantageous because it is in this way possible to restrict the region around the joint between the workpieces to be joined which is heat-affected by friction. In particular if the first outer segment is arranged fixed in terms of rotation and therefore does not rotate relative to the workpieces, and is also preferably cooled, substantially only the region of the workpieces which extends within the outer periphery of the first friction surface is heat-affected. The width of the transition zone between the zone which is melted and the zone which remains unaffected is in particular kept as narrow as possible by the cooled outer segment. This is advantageous because in particular this transition region has proven susceptible to subsequent fracture.

Furthermore, it is preferable for the first friction surface segment to be displaceable in the direction in which the pin extends, so that the apparatus according to the invention can also be used to carry out what is known as spot welding, as described in more detail in WO 01/36144. In this case, the pin, which can likewise be displaced along the axis of rotation in the direction in which it extends, is lowered into two workpieces arranged above one another, while it is rotating, with the pin entering the first workpiece first of all and then entering the second workpiece. The rotation of the pin plasticizes the zone of the workpieces which surrounds the pin, with the plastic material being forced upwards as a result of the downward movement of the pin. If a movement of the friction surface segment away from the workpieces takes place in parallel with the movement of the pin into the workpieces, the material which has been forced out can be received in the annular space formed in this way between friction surface segment and outer segment. If the pin is then moved back out of the workpieces, the friction surface segment can be lowered towards the workpieces, so that the plastic material is pressed back into the hole which has been left by the pin. If this material then solidifies in the hole formed by the pin, a spot-like join ensues between the workpieces located on top of one another. In this way, a friction stir welding apparatus which can be used for different joining geometries and therefore on a universal basis is provided.

It is preferable for the first friction surface segment and the pin to be driven by a first drive, in which case means are provided for setting the rotational speed and direction of rotation of the first friction surface and the pin independently. By using just one drive, it is possible to keep the overall size of the apparatus small and ease of handling is retained. In a preferred embodiment, the different directions of rotation of pin and first friction surface can be realized in a simple way by a reversing mechanism, in which case it is even more preferable to use a bevel gear mechanism in order to further reduce the overall size.

In a further preferred embodiment of the invention, in addition to the first shoulder with the first friction surface, the apparatus has a second shoulder with a second friction surface, the second friction surface being arranged at a distance from the first friction surface, and the second friction surface facing towards the first friction surface. Furthermore, the second friction surface can be set in rotation independently of the pin. The second shoulder also provides a bearing surface, which fixes the position of the workpieces, on that surface of the workpieces which faces away from the first friction surface. The second shoulder also allows the apparatus to carry out what is known as the double shoulder FSW process. The second friction surface, which likewise rotates independently of the pin, can also be used to influence the properties of the weld seam from the underside.

Preferably, the lower shoulder can likewise be set in rotation with a direction of rotation opposite that of the pin, in order in this way to minimize the resulting moment acting on the workpieces.

Also preferably, the distance between the first friction surface and the second friction surface may be variable, so that the workpieces can be held between the first and second shoulders and the pressure acting between the friction surfaces and the workpieces can be controlled.

In a manner which is similar to the first shoulder, it is also possible for the second shoulder to be provided with a friction surface segment, an inner segment and an outer segment, in which case the advantages which have already been explained above in connection with the first shoulder can be achieved as a result.

In a first alternative, the second friction surface segment can likewise be set in rotation by the first drive, resulting in an apparatus with the smallest possible overall size. In a second alternative, however, it is also possible to provide a second drive, which is used to drive the second friction surface segment. In this way, the second friction surface can be controlled independently of the first friction surface, so that the properties of the weld seam can be set even more successfully.

In another preferred embodiment, there is a passage with an outlet opening for introducing filler materials into the weld seam. Filler materials, in particular scandium powder, can be used to deliberately improve the properties of the stir zone in the region of the weld seam. Furthermore, the addition of the filler material allows special alloys to be formed in the region of the weld seam, which can improve the quality of the weld seam. For this purpose, the metal powder can be introduced into the weld seam through a passage in the pin and/or through an opening which may be formed in particular by the gap between the first friction surface segment and the first inner segment, which leads to particularly thorough mixing between the material of the workpieces and the filler material and therefore to a homogeneous weld seam.

In the case of the friction stir welding of workpieces made from aluminium or alloys thereof, the filler materials may in particular be copper, manganese, silicon, magnesium, zinc or aluminium oxide. In this context, copper has the advantage of increasing the tensile strength in the region of the weld seam. Manganese increases the strength without causing a loss of ductility. If silicon is introduced into the region of the weld seam, this reduces the melting temperature of the material which forms the weld seam. Magnesium as filler material is associated with the advantage of increasing the strength and corrosion resistance of the material of the weld seam compared to the aluminium of the workpieces that are to be joined. Zinc and magnesium also improve the tensile strengths. Aluminium oxide as filler material, finally, leads to an improvement in the surface hardness and wear resistance and to an increase in the strength.

Other aspects and advantages of the present invention will be apparent from the following detailed description of the preferred embodiments and the accompanying drawing figures.

### BRIEF DESCRIPTION OF THE DRAWING FIGURES

Preferred embodiments of the invention are described in detail below with reference to the attached drawing figures, wherein:

FIG. 1 shows a first embodiment of a friction stir welding apparatus in accordance with the present invention,

FIG. 2 shows a second embodiment of a friction stir welding apparatus,

FIG. 3 shows a third embodiment of a friction stir welding apparatus,

FIG. 4 shows a fourth embodiment of a friction stir welding apparatus according to the invention, and

FIG. 5 illustrates the drive for an apparatus in accordance with the present invention.

The drawing figures do not limit the present invention to the specific embodiments disclosed and described herein. The drawings are not necessarily to scale, emphasis instead being placed upon clearly illustrating the principles of the preferred embodiment.

### DETAILED DESCRIPTION OF THE PREFERRED EMBODIMENTS

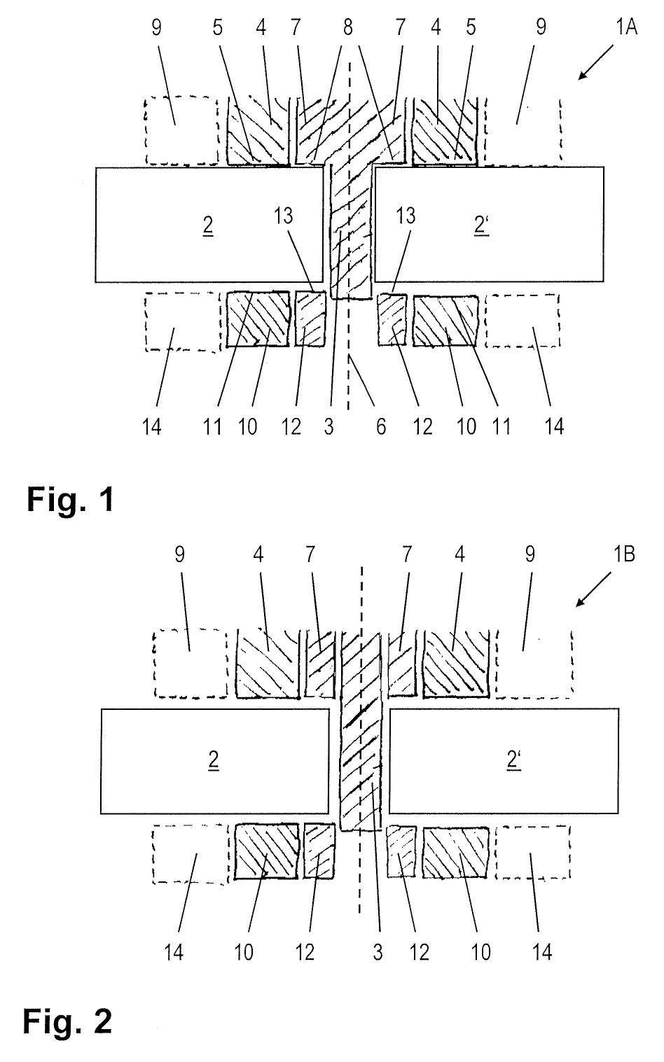

FIG. 1 illustrates a first embodiment of the present invention. The apparatus 1A for friction stir welding, which can be guided for example along the joint along which two workpieces 2, 2′ bear against one another, comprises a pin 3 and a first friction surface segment 4, the first friction surface segment 4 being designed in the form of a circular ring. The pin 3 and the first friction surface segment 4 are rotationally driven about a common axis of rotation 6. In this context, it is on the one hand conceivable to provide separate drives for the pin 3 and the first friction surface segment 4. However, it is also possible to use a first drive jointly for both the pin 3 and the first friction surface segment 4.

The first friction surface segment 4 has a first friction surface 5 for resting on the workpieces 2, 2′. Furthermore, there is a first inner segment 7, which is joined to the pin 3 and is surrounded by the first friction surface segment 4, the first friction surface segment 4 being rotationally driven independently of the first inner segment 7 and therefore independently of the pin 3. In this preferred exemplary embodiment, moreover, the first inner segment 7 is formed integrally with the pin 3. The first inner segment 7 has a larger diameter than the pin 3 and has a first inner friction surface 8, which can rest on the surface of the workpieces 2, 2′. The pin 3 having the first inner segment 7 and the first friction surface segment 4 can be driven at different rotational speeds from one another. In particular, it is possible for the pin 3 and the first friction surface segment 4 to be rotationally driven in opposite directions of rotation to one another.

If the pin 3 and the first friction surface segment 4 are driven in opposite directions of rotation to one another, the torques exerted on the workpieces 2, 2′ by the pin 3 in conjunction with the first inner friction surface 8 are compensated for by the torque exerted on the workpieces 2, 2′ by the first friction surface 5. This compensation means that the holder for the workpieces 2, 2′ does not have to absorb such high forces. This effect is achieved by virtue of the fact that in addition to the peripheral surface of the pin 3, the first inner friction surface 8, which has a larger periphery than the pin 3, also exerts friction forces on the workpieces 2.

Moreover, the apparatus 1A has a first outer segment 9, which surrounds the first friction surface segment 4. The first friction surface segment 4 can rotate freely with respect to the first outer segment 9, and the first outer segment 9 is preferably arranged fixed in terms of rotation with respect to the workpieces 2. In this case, the first outer segment 9 is preferably also coolable, in order to in this way limit the zone of the workpieces 2 which is heat-affected by the frictional energy introduced.

In the embodiment which is preferred in this respect, moreover, the apparatus 1A has a second shoulder, which comprises a second friction surface segment 10 with a second friction surface 11. The second friction surface 11 is arranged at a distance from the first friction surface 5 and faces towards the first friction surface 5. Furthermore, the second friction surface segment 10 and the pin 3 are rotationally driven independently of one another. In particular, the second friction surface segment 10 can be driven with a direction of rotation which is opposite to that of the pin 3, in order once again to ensure that the torques exerted on the workpieces 2, 2′ compensate for one another. To enable workpieces 2, 2′ to be clamped between the friction surfaces 5, 16, the distance between the first friction surface 5 and the second friction surface 11 is variable.

Furthermore, in this preferred exemplary embodiment the second shoulder has a second inner segment 12, which is surrounded by the second friction surface segment 10 and is provided with a second inner friction surface 13 for resting on the workpieces 2, 2′. In this case, the second inner segment 12 is likewise rotationally driven about the axis of rotation 6, in order, like the first inner segment 7, to contribute to compensating for the torques.

Moreover, the second shoulder has a second outer segment 14, which is preferably arranged fixed in terms of rotation with respect to workpieces 2 and is also designed to be coolable, in order to restrict the heat-affected zone of the workpieces 2.

The optionally provided second shoulder having the second friction surface segment 10, the second inner segment 12 and the second outer segment 14 means that the apparatus according to the invention can be used to carry out not just conventional FSW, in which a shoulder rests on only one surface of the workpieces 2, 2′, but also to carry out what is known as the double shoulder FSW welding process.

The apparatus 1A according to the invention can be used to join two workpieces 2, 2′ to one another along a joining surface in such a way that a zone of the first workpiece 2 and/or of the second workpiece 2′ arranged adjacent to the joining surface is plasticized by the pin 3 rotating about the axis of rotation 6. In this context, it is on the one hand conceivable, as shown in FIG. 1, for the joining surface to run along the joint at which the two workpieces bear against one another. In this case, the apparatus 1A with the pin 3 and the friction surface segment 4, which are rotating about the axis of rotation 6, is moved along the joining surface, so that the zones in one or both workpieces 2, 2′ which adjoin the joining surface are plasticized. As the apparatus 1A continues to move along the joining surface, the previously plasticized zone solidifies and the workpieces 2, 2′ form a join with one another. As has already been described above, the structure according to the invention minimizes the forces exerted on the holder for the workpieces 2, 2′.

The second embodiment according to the present invention, which is illustrated in FIG. 2, differs from the embodiment illustrated in FIG. 1 by virtue of the fact that the first inner segment 7 is not fixedly joined to the pin 3, but rather the pin 3 is displaceable linearly along the axis of rotation 6 in the direction in which the pin extends. Furthermore, the first friction surface segment 4 is displaceable in the direction in which the pin 3 extends and can in particular be moved away from the workpieces 2, 2′, so that the apparatus according to the invention can be used to carry out what is known as “spot welding”. In this case, the pin 3, which does not initially protrude beyond the first friction surface 5, is lowered, rotating, into the upper of two workpieces positioned on top of one another, while at the same time the first friction surface segment 4 is moved away from the workpieces 2, 2′, so that material which is displaced by the pin 3 can penetrate into the volume between inner segment 7 and outer segment 9 which has been left by the first friction surface segment 4. When the pin 3 is then pulled back out of the workpieces, the first friction surface segment 4 is moved back towards the workpieces, so that the material is pressed back into the volume left by the pin 3. During this spot welding, the second shoulder, comprising the second friction surface segment 10, the second inner segment 12 and the second outer segment 14, is not required, but rather the workpieces are held on a fixed base by the first outer segment 9.

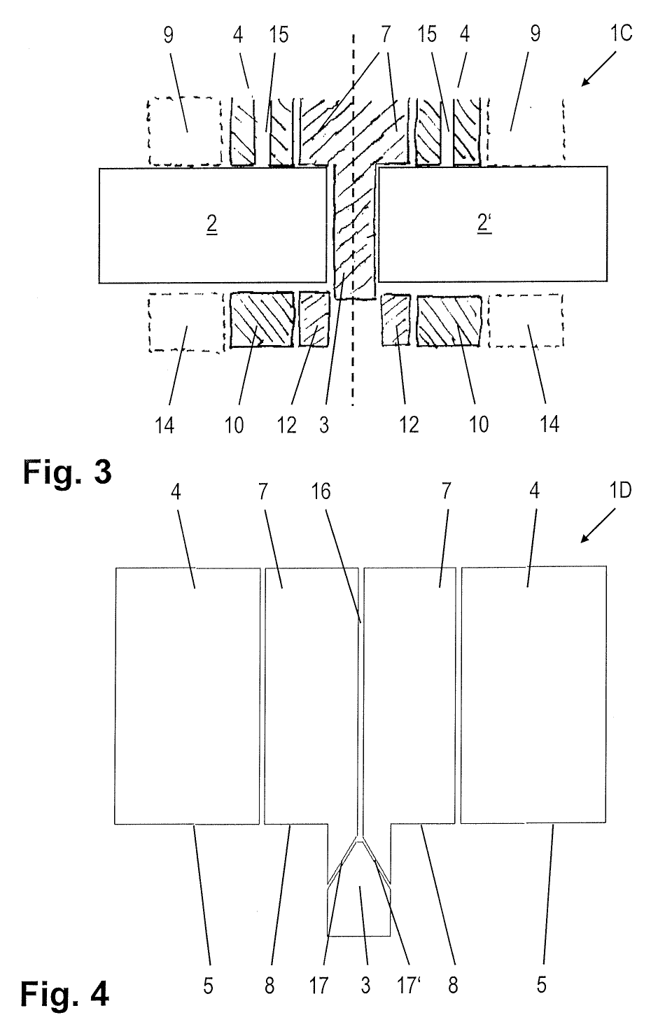

The third embodiment, shown in FIG. 3, of an apparatus 1C according to the invention differs from the first exemplary embodiment, which is illustrated in FIG. 1, by virtue of the fact that friction surface passages 15 are provided in the first friction surface segment 4, in order for a filler material to be introduced into the zone which has been plasticized by the friction with the pin 3, with the inner segment 13 and with the friction surface segment 4.

Alternatively, as in the fourth exemplary embodiment, shown in FIG. 4, of an apparatus 1D, it is possible to provide a central passage in the pin 3, through which a filler material is likewise introduced into the interior of the weld seam. The apparatus 1D once again comprises a pin 3 and a first friction surface segment 4. The first friction surface segment 4 is designed in the form of a circular ring and surrounds the pin 3. In this embodiment, which is preferred in this respect, the feed device is designed as a central passage running within the pin 3 and having a first portion 16, which runs parallel to the axis of rotation 6 in the direction in which the pin 3 extends, and end portions 17, 17′, which extend from the end of the first portion 16 to the circumferential surface of the pin 3.

In the case of friction stir welding of workpieces 2 made from aluminium or alloys thereof, the filler materials may in particular be copper, manganese, silicon, magnesium, zinc or aluminium oxide.

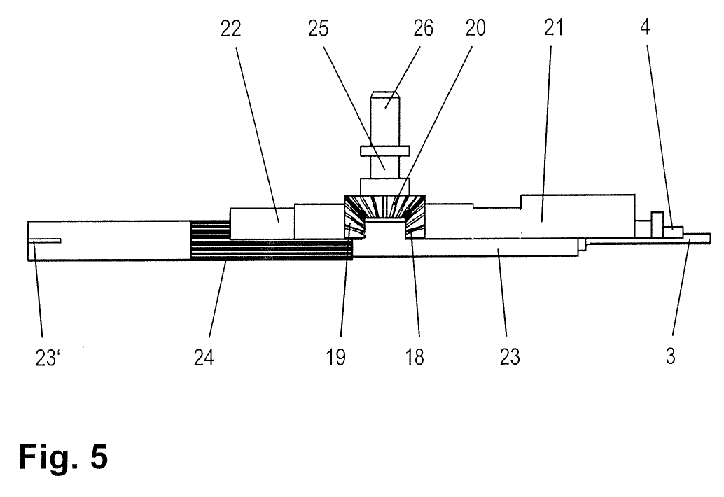

FIG. 5 illustrates an embodiment for a drive for an apparatus according to the present invention. The drive has a reversing mechanism which comprises a first bevel gear 18, a second bevel gear 19 and a third bevel gear 20. The first bevel gear 18 is connected to a first hollow shaft 21, which is in turn connected to the first friction surface segment 4. The second bevel gear 19 is arranged on a second hollow shaft 22, the second hollow shaft 22 being internally toothed. A shaft 23, which is rotationally fixedly connected to the second hollow shaft 22 via a region with external toothing 24, is guided inside the hollow shafts 21 and 22. At the same time, the shaft 23 can be displaced in the axial direction with respect to the hollow shafts 21, 22, so that the pin 3 arranged at the end of the shaft 23 can be displaced axially with respect to the first friction surface segment 4. Consequently, the pin 3 can be displaced linearly in the direction in which it extends and driven in rotation in the process. Moreover, the shaft 23 has a first connection piece 23′, by means of which the reversing mechanism can be connected to a motor.

The third bevel gear 20 is arranged between the first and second bevel gears 18, 19 and is attached to a connection shaft 25 having a second connection piece 26. The bevel gears 18, 19, 20 mesh with one another in the manner illustrated, such that when the connection pieces 23′, 26 are rotated, the shaft 23 rotates in the opposite direction of rotation to the first hollow shaft 21. A drive motor (not shown) may be provided either at the first connection piece 23′ or at the second connection piece 26, depending on the spatial conditions at the friction stir welding apparatus.

The friction stir welding apparatuses according to the present invention which are illustrated in the figures can be used universally for various friction stir welding processes. On the one hand, the conventional friction stir welding process is possible if there is no rotating movement in the second shoulder. Furthermore, by adding the second shoulder, it is possible to carry out what is known as double shoulder friction stir welding. Finally, it is also possible to produce weld spots, since according to the second embodiment the pin 3 and the first friction surface segment 4 can be displaced linearly in the direction of the axis of rotation 6. It is therefore possible to change between different friction stir welding processes without lengthy changeover times and associated costs, making the welding apparatus highly flexible.

The preferred forms of the invention described above are to be used as illustration only, and should not be utilized in a limiting sense in interpreting the scope of the present invention. Obvious modifications to the exemplary embodiments, as hereinabove set forth, could be readily made by those skilled in the art without departing from the spirit of the present invention.

The inventors hereby state their intent to rely on the Doctrine of Equivalents to determine and assess the reasonably fair scope of the present invention as pertains to any apparatus not materially departing from but outside the literal scope of the invention as set forth in the following claims.

What is claimed is:

1. An apparatus for friction stir welding of a workpiece, said apparatus comprising:
a pin;
a first friction surface segment,
said pin and said first friction surface segment being rotationally driven about an axis of rotation,
said first friction surface segment having a first friction surface for resting on the workpiece; and
a first inner segment having a first inner friction surface for bearing against the workpiece,
wherein the first inner segment surrounds the pin, the first friction surface segment surrounds the first inner segment, and the first friction surface segment is rotationally driven independently of the first inner segment.

2. The apparatus according to claim 1,
wherein the first inner segment is joined to the pin.

3. The apparatus according to claim 2,
wherein the first inner segment is formed integrally with the pin.

4. The apparatus according to claim 1,
wherein the pin can be displaced linearly in the direction in which the pin extends.

5. The apparatus according to claim 1,
wherein the pin and the first friction surface segment can be driven at different rotational speeds from one another.

6. The apparatus according to claim 1,
wherein the pin and the first friction surface segment can be rotationally driven in opposite directions of rotation to one another.

7. The apparatus according to claim 1; and
a first outer segment surrounding the first friction surface segment.

8. The apparatus according to claim 7,
wherein the first friction surface segment can rotate freely relative to the first outer segment.

9. The apparatus according to claim 7,
wherein the first outer segment is rotatably fixed.

10. The apparatus according to claim 7,
wherein the first outer segment is coolable.

11. The apparatus according to claim 7,
wherein the first friction surface segment can be displaced in the direction in which the pin extends.

12. The apparatus according to claim 1; and
a first drive for the pin and the first friction surface segment.

13. The apparatus according to claim 12,
wherein the first drive has a reversing mechanism.

14. The apparatus according to claim 13,
wherein the reversing mechanism is designed as a bevel gear mechanism.

15. The apparatus according to claim 1; and
a shoulder having a second friction surface segment with a second friction surface at a distance from the first friction surface,
wherein the second friction surface faces towards the first friction surface, and the second friction surface segment and the pin are rotationally driven independently of one another.

16. The apparatus according to claim 15,
wherein the pin and the second friction surface segment are rotationally driven in opposite directions of rotation to one another.

17. The apparatus according to claim 15,
wherein the distance between the first friction surface and the second friction surface is variable.

18. The apparatus according to claim 15,
wherein the shoulder has a second inner segment, and the second friction surface segment surrounds the second inner segment.

19. The apparatus according to claim 18,
wherein the shoulder has a second outer segment, the second outer segment surrounds the second friction surface segment, and the second friction surface segment can rotate relative to the second outer segment.

20. The apparatus according to claim 19,
wherein the second outer segment is rotatably fixed.

21. The apparatus according to claim 19,
wherein the second outer segment is coolable.

22. The apparatus according to claim 1; and
a feed device for introducing a filler material into a weld seam of the workpiece.

23. The apparatus according to claim 22,
wherein the feed device is formed as a central passage in the pin, the central passage has an outlet opening, and the outlet opening is arranged in that part of the pin which protrudes beyond the first friction surface.

24. The apparatus according to claim 23,
wherein the central passage has a first portion which runs parallel to the axis of rotation in the direction in which the pin extends.

25. The apparatus according to claim 24,
wherein the central passage has an end portion which extends from the end of the first portion to the peripheral surface of the pin.

26. The apparatus according to claim 22,
wherein the feed device is provided as a friction surface passage, which has an outlet opening, in the first friction surface segment, and the outlet opening is arranged in the first friction surface.

27. The apparatus according to claim 22,
wherein the feed device is formed by an inner gap which is formed between the first friction surface segment and the pin.
